(19) United States
(12) Patent Application Publication
(10) Pub. No.: US 2025/0071661 A1
(43) Pub. Date: Feb. 27, 2025

(54) APPARATUS, METHODS, AND COMPUTER PROGRAMS RELATING TO EVENT MONITORING

(71) Applicant: Nokia Technologies Oy, Espoo (FI)

(72) Inventors: Joao Antonio PEREIRA RODRIGUES, Amadora (PT); Hannu Petri HIETALAHTI, Oulu (FI)

(21) Appl. No.: 18/808,717

(22) Filed: Aug. 19, 2024

(30) Foreign Application Priority Data
Aug. 21, 2023 (GB) 2312757.4

(51) Int. Cl. H04W 48/02; H04W 60/00

(52) U.S. Cl. CPC H04W 48/02; H04W 60/00

(57) ABSTRACT

A user equipment comprises at least one processor and at least one memory storing instructions that, when executed by the at least one processor, cause the user equipment at least to perform: generating a message, said message comprising one or more permissions for reporting of user equipment related events to one or more monitoring entities; and causing the message to be sent to one or more controlling network entities.

### CROSS-REFERENCE TO RELATED APPLICATIONS

This patent application claims the benefit of priority of United Kingdom Patent Application No. 2312757.4 filed Aug. 21, 2023, which is hereby incorporated by reference.

### FIELD

This disclosure generally relates to communication systems and in particular but not exclusively to apparatus, methods and computer programs relating to event monitoring_in communication systems.

### BACKGROUND

A communication system can be seen as a facility that enables communications between two or more communication devices, or provides communication devices access to a data network. A mobile or wireless network is one example of a communication system. A communication device may be provided with a service by an application server.

Such communication systems operate in according with standards such as those provided by 3GPP (Third Generation Partnership Project) or ETSI (European Telecommunications Standards Institute). Examples of standards are the so-called 5G (5^{th} Generation) standards provided by 3GPP.

### SUMMARY

According to one aspect, there is provided a user equipment comprising: means for generating a message comprising one or more permissions for reporting of user equipment related events to one or more monitoring entities; and means for causing the message to be sent to one or more controlling network entities.

One shared permission may be provided for a set of two or more different types of user equipment related events.

The user equipment related events may comprise two or more different types of events which are associated with a respective permission.

One or more different permissions are provided for different ones of the one or more monitoring entities.

The one or more permissions may be used by one or more of the one or more controlling network entities to control if a user equipment related event is reported by one or more network entities to a monitoring entity of the one or more monitoring entities.

The message may further comprise a validity period associated with one or more of the one or more permissions.

The message may comprise a registration request.

The user equipment may comprise means for determining that one or permissions for reporting of user equipment related events have changed, means for generating a further message, in response, the further message comprising information about the one or more changed permissions for reporting of user equipment related events, and means for causing the further message to be sent to the one or more controlling network entities.

The user equipment related event may comprise one or more of:
one or more loss of connectivity events;
one or more reachability of the user equipment events;
one or more location of the user equipment events;
one or more change of subscription permanent identifier-permanent equipment identifier association events;
one or more roaming status events;
one or more communication failure events;
one or more availability after downlink data notification failure events;
one or more protocol data unit session status monitoring permissions events;
one or more number of user equipment present in geographical area related;
one or more core network type change events;
one or more downlink data delivery status events;
one or more user equipment reachability for short message service delivery events;
one or more memory of the user equipment available for short message service events;
one or more number of registered user equipment events;
one or more established protocol data unit sessions events;
one or more area of interest events;
one or more group member list change events; or
one or more group-maximum bit rate events.

One or more of the one or more monitoring entities comprises an untrusted monitoring entity.

One or more of the one or more monitoring entities may be provided outside a core network. The one or more controlling network entities may be provided in the core network.

One of the one or more controlling network entities may comprise an apparatus providing an access and mobility function.

One of the one or more controlling network entities may comprise an apparatus providing a user data management function.

According to another aspect, there is provided a user equipment comprising at least one processor and at least one memory storing instructions that, when executed by the at least one processor, cause the user equipment at least to perform: generating a message, said message comprising one or more permissions for reporting of user equipment related events to one or more monitoring entities; and causing the message to be sent to one or more controlling network entities.

According to another aspect, there is provided a method comprising: generating a message, said message comprising one or more permissions for reporting of user equipment related events to one or more monitoring entities; and causing the message to be sent to one or more controlling network entities.

One shared permission may be provided for a set of two or more different types of user equipment related events.

The user equipment related events may comprise two or more different types of user related events which are associated with a respective permission.

One or more different permissions are provided for different ones of the one or more monitoring entities.

The one or more permissions may be used by one or more of the one or more controlling network entities to control if a user equipment related event is reported by one or more network entities to a monitoring entity of the one or more monitoring entities.

The message may further comprise a validity period associated with one or more of the one or more permissions.

The message may comprise a registration request.

The method may comprise determining that one or permissions for reporting of user equipment related events have changed, generating a further message, in response, the further message comprising information about the one or more changed permissions for reporting of user equipment related events, and causing the further message to be sent to the one or more controlling network entities.

The user equipment related events may comprise one or more of:
one or more loss of connectivity events;
one or more reachability of the user equipment events;
one or more location of the user equipment events;
one or more change of subscription permanent identifier-permanent equipment identifier association events;
one or more roaming status events;
one or more communication failure events;
one or more availability after downlink data notification failure events;
one or more protocol data unit session status monitoring permissions events;
one or more number of user equipment present in geographical area related;
one or more core network type change events;
one or more downlink data delivery status events;
one or more user equipment reachability for short message service delivery events;
one or more memory of the user equipment available for short message service events;
one or more number of registered user equipment events;
one or more established protocol data unit sessions events;
one or more area of interest events;
one or more group member list change events; or
one or more group-maximum bit rate events.

One or more of the one or more monitoring entities comprises an untrusted monitoring entity.

One or more of the one or more monitoring entities may be provided outside a core network. The one or more controlling network entities may be provided in the core network.

One of the one or more controlling network entities may comprise an apparatus providing an access and mobility function.

One of the one or more controlling network entities may comprise an apparatus providing a user data management function.

The method may be performed by an apparatus. The apparatus may be a user equipment.

According to another aspect, there is provided an apparatus comprising: means for receiving one or more permissions for reporting of user equipment related events of a first user equipment to one or more monitoring entities; and means for storing the one or more permissions in association with data relating to the first user equipment.

The apparatus may comprise means for receiving a request, said request being a request by one of said one or more monitoring entities for notification of one or more user equipment related events of the first user equipment, and means for determining based on the one or more permissions if the request for notification of one or more user equipment related events of the first user equipment is authorized.

The request from the one monitoring entity may be received via an apparatus providing a network exposure function.

The data relating to the first user equipment may comprise subscriber data.

The apparatus may provide a user data management function.

According to another aspect, there is provided an apparatus comprising at least one processor and at least one memory storing instructions that, when executed by the at least one processor, cause the apparatus at least to perform: receiving one or more permissions for reporting of user equipment related events of a first subscriber user equipment to one or more monitoring entities; and storing the one or more permissions in association with data relating to the first user equipment.

According to another aspect, there is provided a method comprising: receiving one or more permissions for reporting of user equipment related events of a first user equipment to one or more monitoring entities; and storing the one or more permissions in association with data relating to the first user equipment.

The method may comprise receiving a request, said request being a request by one of said one or more monitoring entities for notification of one or more user equipment related events of the first user equipment, and determining based on the one or more permissions if the request for notification of one or more user equipment related events of the first user equipment is authorized.

The request from the one monitoring entity may be received via an apparatus providing a network exposure function.

The data relating to the first user equipment may comprise subscriber data.

The method may be performed by an apparatus. The apparatus may provide a user data management function.

According to another aspect, there is provided an apparatus comprising: means for receiving one or more permissions for reporting of user equipment related events of a first subscriber user equipment to one or more monitoring entities; and means for sending the one or more permissions to an apparatus providing a user data management function.

The one or more permissions for reporting of user equipment related events of the first user equipment may be received from the first user equipment.

The apparatus may provide an access and mobility function.

According to another aspect, there is provided an apparatus comprising at least one processor and at least one memory storing instructions that, when executed by the at least one processor, cause the apparatus at least to perform: receiving one or more permissions for reporting of user equipment related events of a first subscriber user equipment to one or more monitoring entities; and sending the one or more permissions to an apparatus providing a user data management function.

According to another aspect, there is provided a method comprising: receiving one or more permissions for reporting of user equipment related events of a first subscriber user equipment to one or more monitoring entities; and sending the one or more permissions to an apparatus providing a user data management function.

The one or more permissions for reporting of user equipment related events of the first user equipment may be received from the first user equipment.

The method may be performed by an apparatus. The apparatus may provide an access and mobility function.

According to a further aspect, there is provided a computer program comprising instructions, which when executed by an apparatus, cause the apparatus to perform any of the methods set out previously.

According to a further aspect, there is provided a computer program comprising instructions, which when executed cause any of the methods set out previously to be performed.

According to an aspect there is provided a computer program comprising computer executable code which when run cause any of the methods set out previously to be performed.

According to an aspect, there is provided a computer readable medium comprising program instructions stored thereon for performing at least one of the above methods.

According to an aspect, there is provided a non-transitory computer readable medium comprising program instructions which when executed by an apparatus, cause the apparatus to perform any of the methods set out previously.

According to an aspect, there is provided a non-transitory computer readable medium comprising program instructions which when executed cause any of the methods set out previously to be performed.

According to an aspect, there is provided a non-volatile tangible memory medium comprising program instructions stored thereon for performing at least one of the above methods.

In the above, many different aspects have been described. It should be appreciated that further aspects may be provided by the combination of any two or more of the aspects described above.

Various other aspects are also described in the following detailed description and in the attached claims.

### DESCRIPTION OF FIGURES

Embodiments will now be described, by way of example only, with reference to the accompanying Figures in which:

FIG. 1 shows a schematic overview of some embodiments;

FIG. 2 shows a schematic representation of a 5G system in which some embodiments may be provided;

FIG. 3 shows a schematic representation of an apparatus which may implement a respective network function;

FIG. 4 shows a schematic representation of a user equipment;

FIGS. 5a and 5b show a registration procedure of some embodiments;

FIG. 6 shows event exposure procedure of some embodiments;

FIG. 7 shows a first method of some embodiments;

FIG. 8 shows a second method of some embodiments; and

FIG. 9 shows a third method of some embodiments.

### DETAILED DESCRIPTION

Some embodiments relate to permissions for providing (e.g., reporting) of events to a monitoring entity. The events may be user equipment (UE) related events. The permissions may be for providing (e.g., reporting) of the user equipment related events to a monitoring entity.

The monitoring entity may be an application server or an untrusted application function that is external to a core network of a communication system and connected to the core network via a network exposure function of the core network. The core network may be a 3GPP core network (CN) of a 3GPP communication system (hereinafter referred to as 3GPP system) or any other suitable core network.

Currently, a 3GPP core network allows information stored by the 3GPP core network to be accessed by a monitoring entity (e.g., an application server). For example, monitoring entity may access information stored by a 3GPP core network using an event exposure mechanism of the 3GPP core network. An event exposure mechanism is specified for both a 4th generation 3GPP core network, (e.g., an evolved packet core (EPC)) and a 5^{th} generation 3GPP core network (e.g., a 5GC). The event exposure mechanism allows an external service capability server (SCS) and/or application server (AS) connected to an EPC, or an untrusted AF (application function) connected to a 5GC, to subscribe for notifications on the status of certain UEs that are communicating with the 3GPP system. The need for receiving notifications on the status of certain UEs may arise from the needs of the application that is run on the SCS or an AS or untrusted AF.

The SCS, AS and the untrusted AF are some examples of monitoring entities. For example, the monitoring entity may be an AF that has a control plane (CP) part that is connected to a network exposure function (NEF) of a 5GC and configured to request information about the UE from the 5GC. The monitoring entity may have a user plane part that interacts with a user plane (e.g., a UPF) of the 3GPP core network. The user plane part and the control part may be distributed in different entities or provided by a single entity.

A monitoring entity that is connected to a 3GPP core network is generally referred to as an external monitoring entity. An external monitoring entity is configured to subscribe to a 3GPP core network (e.g., an event exposure mechanism of the 3GPP core network) for notifications on user equipment (UE) related events. The 3GPP core network (e.g., the event exposure mechanism of the 3GPP core network) reports to the monitoring entity monitoring event reports with user equipment (UE) related events). However, a privacy issue arises in that a user, subscriber or operator of a network (e.g., core network) associated with a target UE is unable to express consent to being monitored by the network (e.g., core network).

Known monitoring procedures may not involve signalling directly from the UE to the monitoring entity. Rather, one or more network entities of the 3GPP core network may report the UE related events to the external monitoring entity.

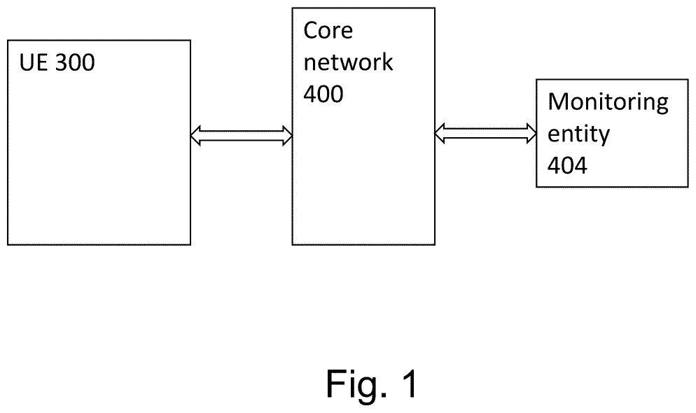

Reference is made to FIG. 1 which shows an overview of some embodiments. A UE 300 is in communication with a core network (CN) 400. A monitoring entity 404 has a subscription for notifications on UE related events or requests information about authorization for monitoring and providing (e.g., report) UE related events from a 3GPP core network using an event exposure mechanism of the 3GPP core network. The UE related events are monitored and provided (e.g., reported) to the monitoring entity by the core network. In some embodiments, UE related events are only monitored and provided (e.g., reported) to the monitoring entity by the core network if a subscriber, a user or operator of the UE allows or gives permission for UE related events to be monitored and provided (e.g., reported) by a core network to the monitoring entity. In some embodiments, the permission for UE related events to be monitored and provided (e.g., reported) by the core network to the monitoring entity may depend on the monitoring entity which has a subscription for UE related event or has requested the 3GPP network provide UE related events to the monitoring entity. In some embodiments, the permission for UE related events to be monitored by the core network and provided (e.g., reported) by the core network to the monitoring entity may depend on a type of UE related event.

Thus, some embodiments a permission to provide (e.g., report) one or more UE related events to a monitoring entity may be given or denied. The permission to monitor and provide (e.g., report) one or more UE related events to a monitoring entity may be regarded as a reporting permission for a UE or a monitoring permission. The monitoring entity may be external to the core network in some embodiments. In some embodiments, the monitoring entity may be part of the core network.

Examples of UE related events may include one or more of UE location (e.g., location of a UE), and number of data connections (PDU (protocol data unit) sessions) that a UE has.

In another example, the monitoring entity may be interested in the registration status or reachability of a telemetry type UE that is using aggressive UE power saving via extended discontinuous reception (eDRX), power save mode (PSM), or mobile initiated communication only (MICO) mode that limits the ability to page the UE. The event exposure mechanism of the 3GPP core network allows the monitoring entity to subscribe for notification event reports by which the 3GPP core network can inform the monitoring entity (e.g., provide to the monitoring entity) using the event exposure mechanism when the target UE registers to the 3GPP core network or when the UE becomes reachable. Reporting permission may be given or denied for the providing reporting of events to the monitoring entity.

Event exposure mechanism via the reporting of monitoring events (e.g., UE related events) may be triggered based upon CN detectable protocol events. The UE and the radio interface may not be directly involved in the event exposure procedure, even though UE communication over the radio interface may lead to the CN sending the monitoring event report. This may be the case where the monitoring entity has subscribed for notifications on a type of UE related event that is related to an ongoing radio interface procedure. Reporting permission for a UE may be given or denied for monitoring and providing (e.g., reporting) of these UE related events by the core network to the monitoring entity.

In the following, some example embodiments, the core network 400 may be a 5G core network of a 5G communication system. However, embodiments may be used in other communication systems including future communication systems, such as 6G communication systems.

FIG. 4 shows a schematic representation of a communication system operating based on a 5^{th} generation radio access technology (generally referred to as a 5G system (5GS)) and in which some embodiments may be implemented. The 5GS may comprise a (radio) access network (RAN) or more generally a 5G access network that may e.g., correspond to a (radio) access network (RAN), to a wireline access gateway (W-AGF), to a N3IWF (non 3GPP interworking function), etc. The 5GS may comprise a 5G core network (5GC), one or more application functions (AF) and one or more data networks (DN). The user equipment (UE) 300 may access or connect to the one or more DNs via the 5GS. It should be appreciated that one or more AFs may be regarded as a monitoring entity. One or more of the AFs may be provided by a third party, different to the 5GC network operator. The AF may provide the control plane part of the monitoring entity as described previously.

The 5G (R)AN may comprise one or more base stations or radio access network (RAN) nodes, such as a gNodeB (gNB). A base station or RAN node may comprise one or more distributed units connected to a central unit.

The 5GC may comprise various network functions, such as an access and mobility management function (AMF), a session management function (SMF), an authentication server function (AUSF), a user data management (UDM), a user plane function (UPF), a network data repository (NRF), a network exposure function (NEF), a service communication proxy (SCP), edge application server discovery function (EASDF), policy control function (PCF), network slice access control function (NSACF), network slice specific authentication and authorization function (NSSAAF), and/or network slicing selection function (NSSF).

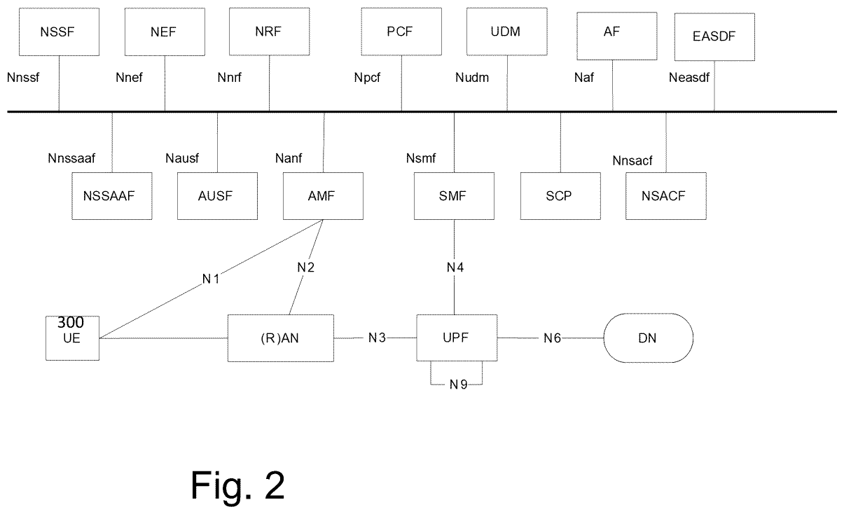

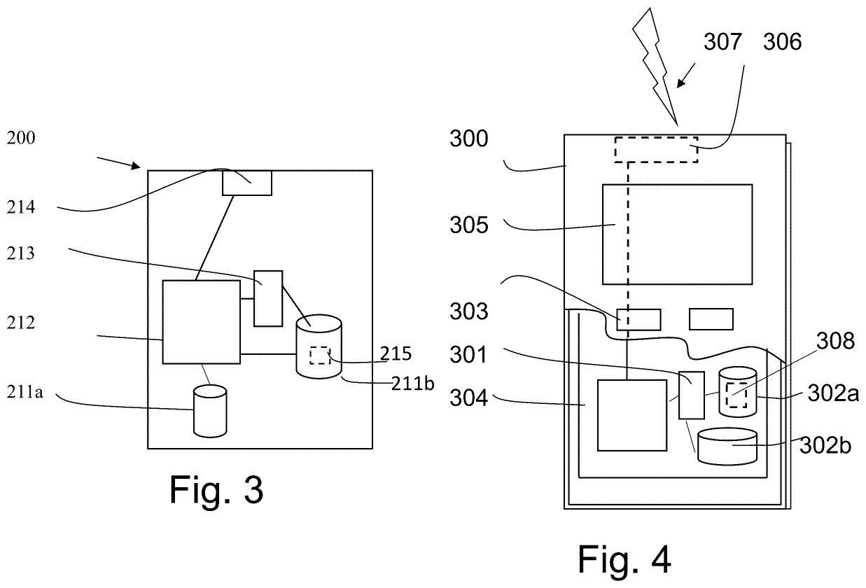

FIG. 3 illustrates an example of an apparatus 200. The apparatus 200 may comprise or implement one or more of the network functions shown in FIG. 2. The apparatus 200 may have at least one processor and at least one memory storing instructions of one or more the network functions shown in FIG. 2 that, when executed by at least one of the at least one processor cause operations or actions of the one or more network functions to be performed. In this example, the apparatus 200 may comprise at least one random access memory (RAM) 211a, and/or at least one read only memory (ROM) 211b. The apparatus 200 may comprise at least one processor 212, 213 and/or a network interface 214. The at least one processor 212, 213 may be coupled to the at least one memory which in this example is the RAM 211a and the ROM 211b. The at least one processor 212, 213 may be configured to execute an appropriate software code 215. The software code 215 may, for example, include software code of one or more of the network functions shown in FIG. 2, including software, which allows the apparatus to perform one or more operations of one or more of the present aspects. For example, the software code 215 may, for example, include software code of the UDM function shown in FIG. 2 or the AMF function of FIG. 2.

FIG. 4 illustrates an example of the communication device 300 or UE. The communication device 300 may be any device capable of or configured for sending and receiving signals. The communication device may be a wireline device or a wireless device. Where the communication device is a wireless device, the signals may be wireless signals such as radio signals. The communication device 300 may comprise a mobile station (MS) or mobile device such as a mobile phone or what is known as a ‘smart phone’, a computer provided with a wireless interface card or other wireless interface facility (e.g., USB dongle), a personal data assistant (PDA) or a tablet, a machine-type communications (MTC) device, a Cellular Internet of things (CIoT) device or any combinations of these or the like. The communication device may be an XR (extended reality) device such as a headset or may be capable of supporting an XR application (e.g., capable of executing or running an XR application). The headset may be a VR headset. The communication device may be or part of a vehicle, a UAV, or a AVV The communication device 300 may be configured to send or receive wireless signals, for example, radio signals carrying communications. The communications may be one or more of voice, electronic mail (email), text message, multimedia, data, machine data and so on.

Where the communication device 300 is a wireless device, the communication device may be configured to send and/or receive wireless signals, for example, radio signals, over an air or radio interface 307 via a transceiver apparatus 306. The transceiver apparatus 306 may comprise, for example, a radio part and associated antenna arrangement. The radio part may convert the base band signal to the radio frequency and/or vice versa. The antenna arrangement may be arranged internally or externally to the mobile device and may include a single antenna or multiple antennas. The antenna arrangement may be an antenna array comprising a plurality of antenna elements.

The communication device 300 may comprise at least one processor 301, and/or at least one memory. The at least one memory may be at least one ROM 302a, and/or at least one RAM 302b. Other possible components 303 may be provided for use in software and hardware aided execution of tasks it is designed to perform, including control of access to and communications with access networks, such as the 5G RAN and other communication devices. The at least one processor 301 is coupled to the RAM 302b and the ROM 302a. The at least one processor 301 may be configured to execute instructions of software code 308. Execution of the instructions of the software code 308 may for example allow the communication device 300 to perform one or more operations. The software code 308 may be stored in the ROM 302a. It should be appreciated that in other embodiments, any other suitable memory may be alternatively or additionally used.

The at least one processor 301, the at least one ROM 302a, and/or the at least one RAM 302b can be provided on an appropriate circuit board, in an integrated circuit, and/or in chipsets. This feature is denoted by reference 304.

The communication device 300 may optionally have a user interface such as keypad 305, touch sensitive screen or pad, combinations thereof or the like. Optionally, the communication device may have one or more of a display, a speaker, and a microphone.

In the following examples, the term UE or user equipment is used. This term encompasses any of the example of communication device 300 previously discussed and/or any other communication device.

In some embodiments, the user of a UE (referred to hereinafter a UE user) may give or deny reporting permission for the UE to allow the network (e.g., the CN 400) to send notifications of UE related events to a monitoring entity 404 which may be external to the CN 400.

In some embodiments, the UE may be programmed or configured with one or more reporting permissions for the UE. In some embodiments, the UE may be programmed or configured with one or more reporting permissions by the UE or owner of the UE. Optionally, the programming or configuring of the UE may be done over the air. For example, when the UE is used by an employee, an employer of the employee may control the reporting permissions for UE related events. In another example, the UE may be a monitoring UE and the owner or operator of the monitoring UE may control the reporting permissions for UE related events.

The reporting permission for a UE may be provided by the UE to the core network 400 when the UE registers with the core network 400. The reporting permission for a UE may be signalled to the core network 400 (e.g., AMF in the case of the core network is a 5GC or MME (mobility management entity) in the case of the core network is an EPC). The AMF or MME may be regarded a controlling network entity. A change of reporting permission for a UE may be signalled to the core network (AMF or MME) by including the change to the reporting permission for a UE a registration procedure that the UE 300 initiates when the UE settings are changed.

The reporting permissions may be changed by the user at the UE, or over the air, or via a network.

This capability for the user of the UE to deny monitoring of one or more specific UE related events or monitoring of all related events can be overridden in the 3GPP core network (e.g., CN 400) if regulatory requirements allow or require a public authority to monitor the UE. In some embodiments, the reporting permission for a UE may only be overridden by an appropriately authorised monitoring entity.

The reporting permission for a UE for a given type of UE related event may apply to any monitoring entity. Alternatively, the reporting permission for a UE for given type of UE related event may apply only to external monitoring entities. Alternatively, the reporting permission for a UE for a given type of UE related event may be set for one or more specified monitoring entities.

The reporting permission for a UE that allows notification event reports (e.g., reports of notifications on UE related events) to be sent can be either active or passive.

For example, the UE can actively provide their reporting permission to the event exposure mechanism of the CN 400 to expose the network information of that UE to an external third party.

The reporting permission for a UE may be included in non-access stratum (NAS) signalling, such as in a registration request included in NAS signalling sent by the UE to the AMF of a 3GPP core network. If the AMF receives NAS signalling that includes an indication of reporting permission for the UE (for example, either YES or NO), the AMF may include the indication in UE CM (connection management) registration message sent by the AMF to the UDM. the UE CM registration message may be sent by the AMF to the UDM via the N8 interface of CN 400.

If no such reporting permission for the UE has been provided by the UE, then the core network falls back to using a pre-configured default reporting permission for the UE that is stored as part of the subscriber data. The default reporting permission for the UE can be set to either allow reporting of UE related events for the subscriber or to deny reporting of UE related events for the subscriber. The default permission for the UE may be set for all UE related events, or for a type of UE related event, or plurality of different types of UE related events. The default reporting permission may set for all monitoring entities, for each monitoring entity, or an a per monitoring entity category basis.

When deciding whether to authorize a notification event subscription from a monitoring entity and which targets a certain UE, the UDM checks the reporting permission for that UE. The UDM may, in addition, check any other already specified authorisation criteria. This other already specified authorisation criteria may be as defined in TS 23.502 clause 4.15.3.2.3 step 2.

If the reporting permission has been already provided to the UDM for the targeted UE, then the UDM uses that reporting permission to determine whether or not to authorize the notification event subscription. If no reporting permissions have been provided to the UDM for the targeted UE, then the UDM may use a pre-configured default setting in the subscriber data to determine whether or not to authorize the notification event subscription.

Some examples of event types are provided in the table below. This tables indicates event types that are specified for 5GS in TS 23.502 clause 4.15.3.1. Some embodiments may be used with one or more of the event types in this table and/or one or more different event types not shown in this table.

| | | Which |
|---|---|---|
| | | NF |
| | | detects |
| | | the |
| Event | Detection criteria | event |
| Loss of | Network detects that the UE is no longer reachable | AMF |
| Con- | for either signalling or user plane communication | |
| nectivity | (see NOTE 4). | |
| | The AF may provide a Maximum Detection Time, | |
| | which indicates the maximum period of time | |
| | without any communication with the UE after | |
| | which the AF is to be informed that the UE is | |
| | considered to be unreachable (see NOTE 7). | |
| | If Unavailability Period Duration has been provided | |
| | by the UE, the AMF uses the remaining value of it | |
| | to determine the foreseen Loss of Connectivity time | |
| | as described in clause 5.4.1.4 of TS 23.501 [2]. | |
| UE | Detected when the UE transitions to CM- | AMF, |
| reach- | CONNECTED state or when the UE will become | UDM |
| ability | reachable for paging, e.g., Periodic Registration | |
| | Update timer. It indicates when the UE becomes | |
| | reachable for sending downlink data to the UE. | |
| | The AF may provide the following parameters: | |
| | 1) Maximum Latency; | |
| | 2) Maximum Response Time; | |
| | 3) Suggested number of downlink packets. (see | |
| | NOTE 5 and NOTE 7). | |
| | This event requires the Reachability Filter set | |
| | to UE reachable for DL traffic″ (see clause | |
| | 5.2.2.3.1-1). For the usage of this event, see | |
| | clauses 4.2.5.2 and 4.2.5.3. | |
| | When requesting UE reachability monitoring, the | |
| | AF may in addition request Idle Status Indication to | |
| | be included in the UE reachability event reporting. | |
| Location | This event is detected based on the Event Reporting | AMF, |
| Reporting | Information Parameters that were received in the | GMLC |
| | Monitoring Request (one-time reporting, maximum | |
| | number of reports, maximum duration of reporting, | |
| | periodicity, etc. as specified in clause 4.15.1). | |
| | It reports either the Current Location or the Last | |
| | Known Location of a UE. | |
| | When AMF is the detecting NF: | |
| | One-time and Continuous Location Reporting are | |
| | supported. For Continuous Location Reporting the | |
| | serving node(s) sends a notification every time it | |
| | becomes aware of a location change, with the | |
| | granularity depending on the accepted accuracy of | |
| | location (see NOTE 1). | |
| | For One-time Reporting with immediate reporting | |
| | flag set, AMF reports the Last Known Location | |
| | immediately. | |
| | When AMF is the detecting NF: | |
| | If the immediate reporting flag is not set, the AMF | |
| | reports the UE Current Location (In case the AMF | |
| | does not have the UE current location in the | |
| | granularity as requested by the location report, the | |
| | AMF retrieves the information via NG-RAN | |
| | Location reporting procedure as defined in clause | |
| | 4.10). When GMLC is the detecting NF: | |
| | Immediate and Deferred Location Reporting is | |
| | supported. For Deferred Location Reporting the | |
| | event types UE availability, Area, Periodic | |
| | Location and Motion are supported. | |
| Change of | This event is detected when the association | UDM |
| SUPI-PEI | between PEI and subscription (SUPI) changes | |
| (sub- | (USIM change). | |
| scription | | |
| permanent | | |
| identifier | | |
| permanent | | |
| equipment | | |
| identifier) | | |
| association | | |
| Roaming | This event is detected based on the UE's current | UDM |
| status | roaming status (the serving PLMN and/or whether | |
| | the UE is in its HPLMN) and notification is sent | |
| | when that status changes. (see NOTE 2). | |
| | If the UE is registered via both 3GPP and N3GPP | |
| | Access Type, then both instances of Roaming | |
| | status are included. | |
| Com- | This event is detected when RAN or NAS level | AMF |
| munication | failure is detected based on connection release | |
| failure | and it identifies RAN/NAS release code. | |
| Availability | This event is detected when the UE becomes | AMF |
| after | reachable again after downlink data delivery failure. | |
| Downlink | When requesting Availability after Downlink Data | |
| Data | Notification failure monitoring, the AF may in | |
| Notification | addition request Idle Status Indication to be | |
| failure | included in the UE reachability event reporting. | |
| PDU | This event is detected when PDU session is | SMF |
| Session | established or released. (see NOTE 6) | |
| Status | | |
| Number | This event is detected based on the Event | AMF |
| of UEs | Reporting Information Parameters that were | |
| present | received in the Monitoring Request (Level of | |
| in a | aggregation, Sampling ratio, see clause 4.15.1). | |
| geo- | It indicates the number of UEs that are in the | |
| graphical | geographical area described by the AF. The AF | |
| area | may ask for the UEs that the system knows by its | |
| | normal operation to be within the area (Last | |
| | Known Location) or the AF may request the | |
| | system to also actively look for the UEs within | |
| | the area (Current Location). | |
| CN Type | The event is detected when the UE moves between | UDM |
| change | EPC and 5GC. It indicates the current CN type for | |
| | a UE or a group of UEs when detecting that the UE | |
| | switches between being served by a MME and an | |
| | AMF or when accepting the event subscription. | |
| | (see NOTE 3) | |
| Downlink | It indicates the downlink data delivery status in the | SMF |
| data | core network. Events are reported at the first | |
| delivery | occurrence of packets being buffered, transmitted | |
| status | or discarded, including: | |
| | Downlink data in extended buffering, including: | |
| | First data packet buffered event | |
| | Estimated buffering time, as per clause 4.2.3.3 | |
| | First downlink data transmitted event | |
| | First downlink data discarded event | |
| UE | For SMS over NAS, this event is detected when | UDM |
| reach- | an SMSF is registered for a UE and the UE is | |
| ability | reachable as determined by the AMF and the UDM. | |
| for SMS | For SMS over IP, the event is detected when the | |
| delivery | UE is reachable as determined by the AMF and the | |
| | UDM regardless of an SMSF being registered. | |
| | This enables the UE to receive an SMS. See | |
| | clauses 4.2.5.2 and 4.2.5.3 (see NOTE 8). | |
| UE | This event is detected when the UE memory is | UDM |
| memory | available for SMS as determined by the AMF and | |
| available | the UDM. This enables to trigger Alert for SMS. | |
| for SMS | See clause 5.1.8 of TS 23.540 [84] | |
| Number of | It indicates the current number of registered UEs | NSACF |
| registered | or established PDU Sessions for a network slice | |
| UEs or | that is subject to NSAC. | |
| established | For One-time Reporting with Immediate Reporting | |
| PDU | Flag set, NSACF reports the number of registered | |
| Sessions | UEs or established PDU Sessions immediately. | |
| Area Of | It indicates change of the UE presence in the | AMF, |
| Interest | Area Of Interest. | GMLC |
| Group | It indicates the changes on the members of the | UDM |
| Member | group. This event apply to a group of UEs | |
| List | (identified by an External Group ID), such | |
| Change | as 5G VN group (see NOTE 9) or other groups. | |
| Group- | The bit rates of a set of specific QoS flows of a | AF |
| MBR | group of UEs' PDU sessions are reported by the | |
| monitoring | UEs' respective serving PSA UPFs to NEF. The | |
| | collected bit rates reported by UPFs are aggregated | |
| | by the NEF. The aggregated bit rate is then | |
| | compared against the AF provisioned Group- | |
| | MBR threshold. If the aggregated bit rate | |
| | exceeds the Group-MBR threshold, the NEF | |
| | notifies the AF for such NEF event. | |

NOTE 1:
Location granularity for event request, or event report, or both could be at cell level (Cell ID) or TA level. The granularity can also be expressed by other formats such as geodetic uncertainty shapes (e.g. polygons, circles, etc.) or civic addresses (e.g. streets, districts, etc.) which can be mapped by NEF to AMF specific granularity levels.
NOTE 2:
Roaming status means whether the UE is in HPLMN or VPLMN based on the most recently received registration state in the UDM.
NOTE 3:
CN type of CN Type change event is defined in clause 5.17.5.1 of TS 23.501 [2].
NOTE 4:
In the case of UDM service operation information flow, the UDM should set the subscribed periodic registration timer to a smaller value than the value of Maximum Detection Time, since the value of the mobile reachable timer is larger than the value of the periodic registration timer.
NOTE 5:
Maximum Latency, Maximum Response Time and Suggested number of downlink packets are defined in clause 4.15.6.3a.
NOTE 6:
The NEF makes a mapping between the 5GS internal event ″PDU Session Status″ and the T8 API event ″PDN Connectivity Status″.
NOTE 7:
The preferred method for provisioning Network Configuration Parameters is External Parameter Provisioning specified in clause 4.15.6.3a. Provisioning event specific parameters as part of Monitoring Request is expected to be used only by the AF that does not support Parameter Provisioning procedure specified in clause 4.15.6.3a.
NOTE 8:
The NEF maps between the T8 API event ″UE reachability″ with reachability type SMS and the 5GS internal event ″UE reachability for SMS delivery″ for SMS over NAS. The event ″UE reachability for SMS delivery″ for SMS over IP is used by HSS as described in clause 5.5.6.3 of TS 23.632 [68].
NOTE 9:
5G VN group management is defined in the clause 5.29.2 of TS 23.501 [2].

The reporting permission for the UE, either explicitly indicated in NAS procedure or stored as part of subscriber data may be for a specific type of UE related event. For example, the reporting permission for the UE may allow the core network (e.g., CN 400) to provide information that is necessary for UE reachability to an external monitoring entity. The reporting permission for the UE allows the external monitoring entity to communicate with the UE. However, the reporting permission for the UE may not allow the core network to provide (e.g., report) UE related events to the monitoring entity that, for example, reveal subscriber related information. For example, the reporting permission for the UE may not allow the core network (e.g., CN 400) to provide (e.g., report) UE related events such as UE location or roaming status to the monitoring entity.

Thus, the reporting permission for the UE may be granted or denied on a per event type basis (e.g., reporting permission for the UE may be granted or denied for each type of UE related event). For example, a monitoring entity may provide (e.g., report) a UE related event, for example, a reachability status of a UE, by allowing one or more monitoring events such loss of connectivity, UE reachability, PDU session status, and/or UE reachability for SMS (short message service) delivery. If at the same time, it is undesired that a monitoring entity be allowed to know the geo-location of the UE, then reporting permission for the UE would be denied for UE related events about location reporting.

One or more of the reporting permissions for UE may be associated with a validity period. At the end of the validity period, the reporting permission may revert to a default reporting permission or to revert to the opposite reporting permission.

The reporting permission for the UE indicated by the UE or a pre-configured reporting permission for the UE may allow a core network (e.g., CN 400) to provide (e.g., report) UE related events to a specific monitoring entity. For example, the reporting permission for a UE may allow the monitoring entity associated with an employer to have access to any UE related event, such as roaming or location related events for the UE of an employee and at the same time to prevent a different monitoring entity from having access to the roaming or location related events for that same UE.

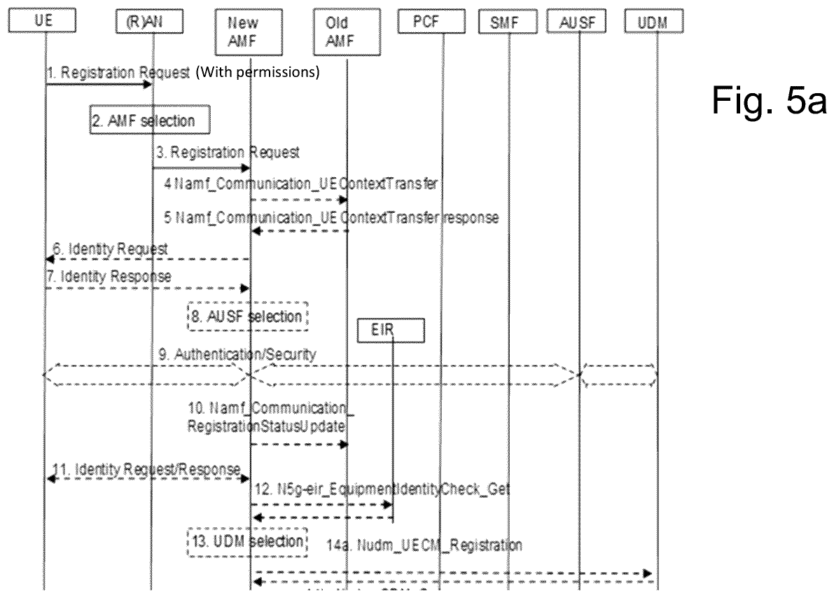

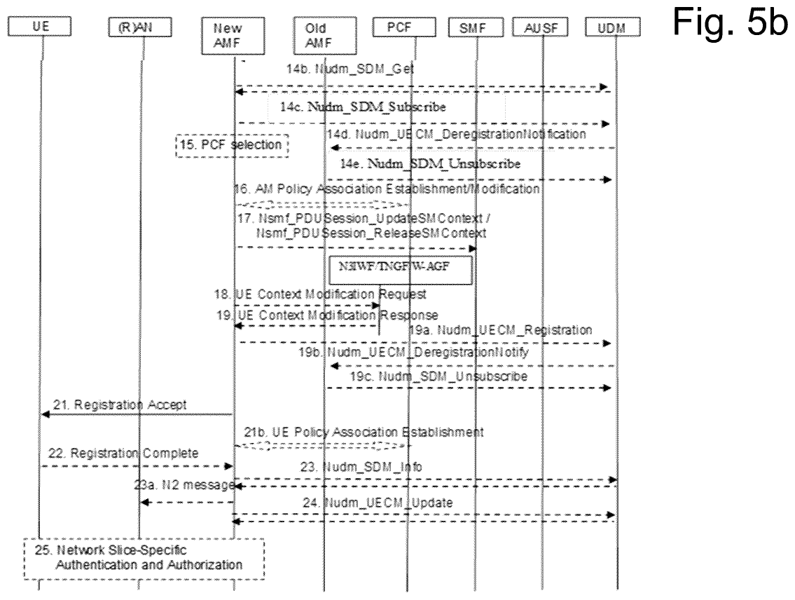

Reference is now made to FIGS. 5a and 5b which show an example procedure in which the permissions for event notification reporting (referred to herein as events notification permission(s)) are signalled to a core network (e.g., a 3GPP core network) as part of a registration procedure. In this example, the permissions for event notification reporting are signalled to the core network in a NAS procedure (e.g., a registration procedures). The procedure shown in FIGS. 5a and 5b are based on the registration procedure set out in TS 23.502 clause 4.2.2.2. It should be appreciated that this is by way of example, and in other examples the permissions for event notification reporting may be provided to a core network in any other suitable way.

Thus, in the example of FIGS. 5a and 5b, the UE signals the event notification permission(s) during a NAS procedure, such as in a registration request message sent by the UE during a registration procedure. The event notification permission(s) may be as discussed previously. This event notification permission(s) is received by the AMF. The AMF informs the UDM of the event notification permission(s). The AMF may inform the UDM of event notification permission(s) by sending a Nudm_UECM_Registration message or other suitable message to the UDM that includes the event notification permission(s).

It should be appreciated that, in some embodiments, even without mobility to another TA (tracking area) or the expiry of a periodic update timer expiry, the UE can make additional registration updates when there is a change to the UE monitoring permissions settings.

In some embodiments, the UE will get another new trigger to initiate additional registration if the monitoring permissions for the UE change. This additional registration may be initiated in 5GS by the UE sending a registration request as shown in FIG. 5a.

At 1, the UE provides one or more monitoring permissions to allow or the deny notification event reports. The monitoring permission for reporting of UE related events are provided in (e.g., included in) the registration request that is sent by the UE to the RAN. The monitoring permissions associated with the reporting of UE related events may be as discussed previously. The monitoring permission(s) may be set by the user of the UE or otherwise set as previously described.

At 2, the RAN selects an AMF (the new AMF).

At 3, the RAN sends the registration request including the monitoring permission to the selected AMF (the new AMF).

At 4, optionally the selected AMF sends a UE context transfer request to the old AMF. This request may be a Namf_Communication_UEContextTransfer request.

At 5, the old AMF provides a UE context transfer response to the new AMF.

At 6, if the SUCI (subscriber concealed identity) is not provided by the UE nor retrieved from the old AMF, the identity request procedure is initiated by AMF sending an identity request message to the UE requesting the SUCI.

At 7, the UE responds with an identity response message including the SUCI.

At 8, the AMF selects an AUSF.

At 9, the UE is authenticated. This involves the AUSF, the new AMF and the UDM.

At 10, the new AMF informs the old AMF that the registration of the UE in the new AMF is completed, for example, by invoking the Namf_Communication_RegistrationStatusUpdate service operation.

At 11, the AMF may send an identity request to the UE and the UE provides the PEI (permanent equipment identifier) in response.

At 12, the new AMF may initiate an ME (mobile equipment) identity check with an EIR (equipment identity register). The EIR carries out the identity check and provides a response.

At 13, the new AMF selects a UDM, if this is required.

At 14a, the new AMF registers with the UDM for the access to be registered. This may be done using Nudm_UECM_Registration. The AMF informs the UDM of the monitoring permission included in the registration request in the case the monitoring permissions were provided in the register request in the part of the procedure referencedreceived at 1. The UDM stores this indication as part of the subscriber data.

At 14b, the if the new AMF does not have subscription data for the UE, the AMF retrieves the subscription data for the UE, SMF selection subscription data, UE context in SMF data and LCS mobile origination. This may be done using Nudm_SDM_Get.

At 14c, the AMF subscribes to be notified by the UDM when the data requested is modified. This may be done using Nudm_SDM_Subscribe.

At 14d, the UDM initiates a deregistration procedure with the old AMF. This may be done using a Nudm_UECM_DeregistrationNotification.

At 14c, the old AMF unsubscribes with the UDM for subscription data. This may be done using a Nudm_SDM_unsubscribe.

At 15, the new AMF may select a new PCF.

At 16, the new AMF and the new PCF may perform AM (access and mobility) policy association establishment.

At 17, the AMF may send a session context update (e.g., a Nsmf_PDUSession_UpdateSMContext) or session context release (e.g., a Nsmf_PDUSession_ReleaseSMContext towards the SMF.

At 18, if the new AMF and the old AMF are in the same PLMN, the new AMF sends a UE context modification request to N3IWF (Non-3GPPP Inter-Working Function), TNGF (Trusted Non-3GPP Gateway Function) or a W-AGF (Wireline Access Gateway Function).

At 19, N3IWF, TNGF, or W-AGF sends a UE Context Modification Response to the new AMF, if this is required.

AT 19a, after the new AMF receives the UE Context Modification Response from the N3IWF, W-AGF or TNGF at 19, the new AMF may need to register its profile with the UDM. The AMF may register its profile with the UDM using Nudm_UECM_Registration with the Access Type set to “non-3GPP access”. The AMF informs the UDM of the monitoring permission included in the registration request in the case the monitoring permissions were included in the register request at 1. The UDM stores the monitoring permission as part of the subscriber data.

At 19b, the UDM initiates a deregistration process with the old AMF. This may be done using Nudm_UECM_DeregistrationNotification.

At 19c, the Old AMF unsubscribes with the UDM for subscription data. This may be done using Nudm_SDM_unsubscribe.

At 21, the new AMF may send a registration accept message to the UE.

As 21b, the new AMF performs a UE policy association establishment with the PCF.

As 22, the UE sends a registration complete message to the new AMF.

As 23, if the Access and Mobility Subscription data provided by the UDM to the new AMF in 14b includes steering of roaming information with an indication that the UDM requests an acknowledgement of the reception of this information from the UE, the AMF provides the UE acknowledgement to UDM. This may be done using Nudm_SDM_Info. If the monitoring permissions have been updated, the AMF may also provide the updated monitoring permissions to the UDM.

At referenced 23a. for Registration over 3GPP Access, if the AMF does not release the signalling connection, the AMF sends the RRC inactive assistance information to the RAN.

At 24, after step 14a and in parallel to any of the preceding steps, the AMF shall send a “homogeneous support of IMS voice over PS sessions” indication to the UDM using Nudm_UECM_Update. If the monitoring permissions have been updated, the AMF may also provide the updated monitoring permissions to the UDM. This “homogeneous support of IMS (IP Multimedia Subsystem) voice over PS (packet switched) sessions” indication is sent if:
If the AMF has evaluated the support of IMS Voice over PS Sessions; and
If the AMF determines that it needs to update the Homogeneous Support of IMS Voice over PS sessions.

At 25, if the UE indicates its support for network slice-specific authentication and authorization the related procedure is executed at this step.

As mentioned, it may be optional for a monitoring permission or permissions for a UE to be provided. According, the monitoring permissions for a UE may not be provided or available from the UE. Where there is no such monitoring permission for a UE, a default monitoring permission or permissions for the UE may be used. A default monitoring permission for a UE may be to allow monitoring of UE related events or the default monitoring permission may be that monitoring of UE related events is not allowed or denied.

In some embodiments, the default monitoring permission for a UE may be to allow monitoring of UE related events.

The default monitoring permission may be changed by sending a request, such as the registration request previously described, with the user preferences for the monitoring permissions. The user's preferences for monitoring permissions are stored in the subscription data stored in the UDM and/or UDR.

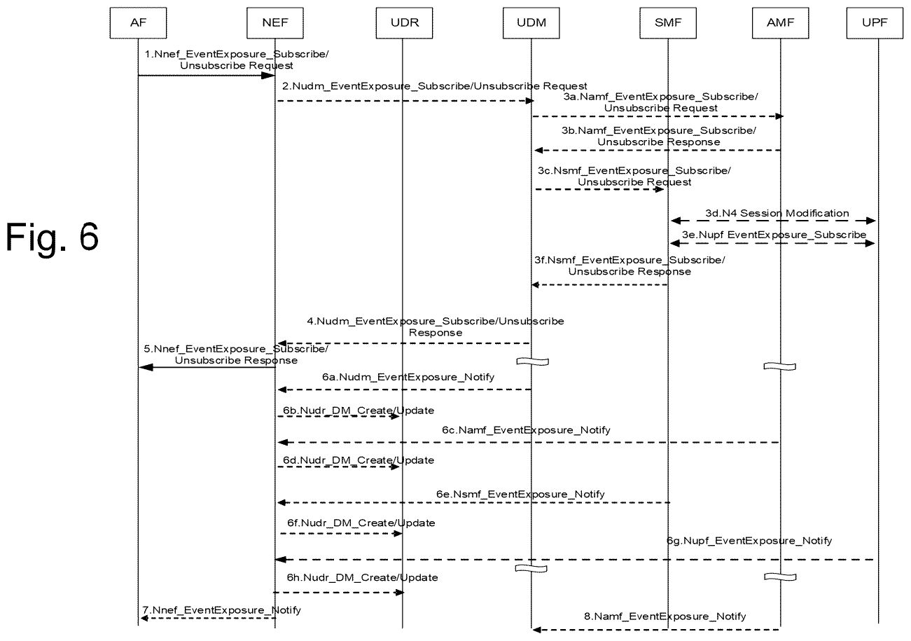

Reference is now made to FIG. 6 which show an example event exposure procedure in which the permissions for event notification reporting are used to determine if a subscription for one or more events associated with a UE can be reported to a monitoring entity. The procedure shown in FIG. 6 are based on the event exposure procedure set out in TS 23.502 clauses 4.15.3.2.2 and 4.15.3.2.3.

The procedure shown in FIG. 6 may be used by the AF to subscribe to event notifications, to modify group-based subscriptions to event notification or to explicitly cancel a previous subscription.

The following is an extract from TS 23.502 4.15.3.2.3-NEF service operations information flow which discusses the procedure of FIG. 6.

However, in some embodiments, the part of the procedure referenced 2 is modified. If the UDM has received one or more permissions for event notification reporting for a UE and/or one or more event types specified by an event notification subscription, then the UDM uses those one or more permissions to determine whether to authorize the notification event subscription or not.

If the UDM has not received any permissions for the UE and/or one or more event types specified by an event notification subscription, then the UDM uses one or more default notification event permissions to determine whether to authorize the notification event subscription or not.

1. The AF subscribes to one or several Event(s) (identified by Event ID) and provides the associated notification endpoint of the AF by sending Nnef_EventExposure_Subscribe request.
Event Reporting Information defines the type of reporting requested (e.g., one-time reporting, periodic reporting or event-based reporting, for Monitoring Events). If the reporting event subscription is authorized by the NEF, the NEF records the association of the event trigger and the requester identity. The subscription may also include Maximum number of reports and/or Maximum duration of reporting IE and optionally MTC Provider Information.

If subscription to group-based event notifications are removed or added for certain UEs in a group of UEs for which there is an event notification subscription, the AF provides impacted UE information (e.g. SUPI, MSISDN (Mobile Station International Subscriber Directory Number), or External Identity) with operation indication which is either cancellation or addition to NEF via Nnef_EventExposure_Subscribe without cancelling the entire group-based event notification subscription.

2. [Conditional—depending on authorization in step 1] The NEF subscribes to received Event(s) (identified by Event ID) and provides the associated notification endpoint of the NEF to UDM by sending Nudm_EventExposure_Subscribe request. The NEF may either receive DNN data network name), S-NSSAI (single network slice selection assistance information) from AF in step 1 or maps the AF-Identifier into DNN and S-NSSAI combination based on local configuration and include DNN, S-NSSAI in the request.

If the reporting event subscription is authorized by the UDM, the UDM records the association of the event trigger and the requester identity. Otherwise, the UDM continues in step 4 indicating failure.

If Nnef_EventExposure_Subscribe with update is received in step 1 indicating removal of event notification subscription for certain UEs in a group of UEs for which there is an event notification subscription, the NEF provides impacted UE information (e.g., SUPI, MSISDN or External Identity) with indication via operation (cancellation) to UDM Nudm_EventExposure_Subscribe without cancelling the entire group-based event notification subscription. If the Maximum Number of Reports applies to the event subscription, the NEF sets the stored number of reports of the indicated UE(s) to Maximum Number of Reports.

If Nnef_EventExposure_Subscribe with update is received in step 1 indicating addition of event notification subscription for certain UEs in a group of UEs for which there is an event notification subscription, the NEF provides impacted UE information (e.g., SUPI, MSISDN or External Identity) with operation indication (addition) to UDM via Nudm_EventExposure_Subscribe.

3a. [Conditional] If the requested event (e.g., monitoring of Loss of Connectivity) requires AMF assistance, then the UDM sends the Namf_EventExposure_Subscribe to the AMF serving the requested user. The UDM sends the Namf_EventExposure_Subscribe request to all the serving AMF(s) (if subscription applies to a UE or a group of UE(s)), or all the AMF in the same PLMN as the UDM (if subscription applies to any UE).
NOTE 1: If the UE, which is a member of a group, registers with an AMF which does not have group event subscription(s) for that group, then the UDM creates subscriptions to those event(s) with the AMF during the Registration procedure in clause 4.2.2.2.2.

As the UDM itself is not the Event Receiving NF, the UDM shall additionally provide the notification endpoint of itself besides the notification endpoint of NEF. Each notification endpoint is associated with the related (set of) Event ID(s). This is to assure the UDM can receive the notification of subscription change related event.

If the subscription applies to a group of UE(s), the UDM shall include the same notification endpoint of itself, i.e., Notification Target Address (+Notification Correlation Id), in the subscriptions to all UE's serving AMF(s).

NOTE 2: The same notification endpoint of UDM is to help the AMF identify whether the subscription for the requested group event is same or not when a new group member UE is registered.

If Nudm_EventExposure_Subscribe with update is received in step 2 indicating removal of event notification subscription for certain UEs in a group of UEs for which there is an event notification subscription, the UDM provides impacted UE information (e.g., SUPI, MSISDN) with operation indication (cancellation) to AMF via Namf_EventExposure_Subscribe without cancelling the entire group-based event notification subscription, for the event monitored by AMF.

If Nudm_EventExposure_Subscribe with update is received in step 2 indicating addition of event notification subscription for certain UEs in a group of UEs for which there is an event notification subscription, the UDM provides impacted UE information (e.g., SUPI, MSISDN) with operation indication (addition) to AMF via Namf_EventExposure_Subscribe for the event monitored by AMF.

3b. [Conditional] AMF acknowledges the execution of Namf_EventExposure_Subscribe.
3c. [Conditional] If the requested event (e.g., PDU Session Status) requires SMF assistance, then the UDM sends the Nsmf_EventExposure_Subscribe Request message to each SMF where at least one UE identified in step 2 has a PDU session established. The NEF notification endpoint received in step 2 is included in the message.
NOTE 3: In the home routed case, the UDM sends the subscription to the V (visitor)-SMF via the H (home)-SMF.
3d-c. [Conditional] If the requested event (e.g., UserDataUsageMeasures) requires UPF assistance, the SMF sends the request to the UPF including the NEF notification endpoint received in step 3c according to step 4 in FIG. 4.15.4.5.2-1.
3f. [Conditional] The SMF acknowledges the execution of Nsmf_EventExposure_Subscribe.
4. [Conditional] UDM acknowledges the execution of Nudm_EventExposure_Subscribe.

If the subscription is applicable to a group of UE(s) and the Maximum number of reports is included in the Event Report information in step 1, the Number of UEs (including all group member UEs irrespective of their registration state) is included in the acknowledgement. If AMF or SMF provides the first event report in step 3b or step 3d, the UDM includes the event report in the acknowledgement.

5. NEF acknowledges the execution of Nnef_EventExposure_Subscribe to the requester that initiated the request. If the NEF has received the first event report already in step 4, the NEF includes the event report in the acknowledgement.
6a-6b. [Conditional-depending on the Event] The UDM (depending on the Event) detects the event occurs and sends the event report, by means of Nudm_EventExposure_Notify message to the associated notification endpoint of the NEF along with the time stamp. NEF may store the information in the UDR along with the time stamp using either Nudr_DM_Create or Nudr_DM_Update service operation as appropriate.

If Nudm_EventExposure_Subscribe with update is received in step 2 indicating removal of event notification subscription for certain UEs in a group of UEs for which there is an event notification subscription, the UDM shall stop the event notification for the impacted UEs. If Maximum number of Reports is applied, the UDM shall set the number of reports of the indicated UE(s) to Maximum Number of Reports for the events monitored by UDM.

If Nudm_EventExposure_Subscribe with update is received in step 2 indicating addition of event notification subscription for certain UEs in a group of UEs for which there is an event notification subscription, the UDM shall create subscription to the event notification for the impacted UEs so as to detect the monitored event and send the event report for such impacted UEs.

6c-6d. [Conditional-depending on the Event] The AMF detects the event occurs and sends the event report, by means of Namf_EventExposure_Notify message to associated notification endpoint of the NEF along with the time stamp. NEF may store the information in the UDR along with the time stamp using either Nudr_DM_Create or Nudr_DM_Update service operation as appropriate.

If the AMF has a maximum number of reports stored for the UE or the individual member UE, the AMF shall decrease its value by one for the reported event.

If Namf_EventExposure_Subscribe with update is received in step 3a indicating removal of event notification subscription for certain UEs in a group of UEs for which there is an event notification subscription, the AMF shall stop the event notification for the impacted UEs. If Maximum number of Reports is applied, the AMF shall set the number of reports of the indicated UE(s) to Maximum Number of Reports.

If Namf_EventExposure_Subscribe with update is received in step 3a indicating addition of event notification subscription for certain UEs in a group of UEs for which there is an event notification subscription, the AMF shall create subscription to the event notification for the impacted UEs so as to detect the monitored event and send the event report for such impacted UEs.

For both step 6a and step 6c, when the maximum number of reports is reached and if the subscription is applied to a UE, The NEF unsubscribes the monitoring event(s) to the UDM and the UDM unsubscribes the monitoring event(s) to AMF serving for that UE.

For both step 6a and step 6c, when the maximum number of reports is reached for an individual group member UE, the NEF uses the Number of UEs received in step 4 and the Maximum number of reports to determine if reporting for the group is complete. If the NEF determines that reporting for the group is complete, the NEF unsubscribes the monitoring event(s) to the UDM and the UDM unsubscribes the monitoring event(s) to all AMF(s) serving the UEs belonging to that group.

NOTE 4: If an expiry time as specified in clause 6.2.6.2.6 of TS 29.518 is not included in the event subscription, then the lifetime of the event subscription needs to be controlled by other means as there is no time-based cancellation at all even if any group member UEs fail to register.

When the Maximum duration of reporting expires in the NEF, the UDM and the AMF, then each of these nodes shall locally unsubscribe the monitoring event.

6c-6f. [Conditional-depending on the Event] When the SMF detects a subscribed event, the SMF sends the event report, by means of Nsmf_EventExposure_Notify message, to the associated notification endpoint of the NEF provided in step 3c. NEF may store the information in the UDR along with the time stamp using either Nudr_DM_Create or Nudr_DM_Update service operation as appropriate.

6g-6h. [Conditional-depending on the Event] When the UPF detects a subscribed event, the UPF sends the event report, by means of Nupf_EventExposure_Notify message, to the associated notification endpoint of the NEF provided by the SMF to UPF as part of step 3c. The NEF may store the information in the UDR along with the time stamp using either Nudr_DM_Create or Nudr_DM_Update service operation as appropriate.

7. [Conditional-depending on the Event in steps 6a-6f] The NEF forwards to the AF the reporting event received by either Nudm_EventExposure_Notify and/or Namf_EventExposure_Notify. In the case of the PDU Session Status event, the NEF maps it to an PDN Connectivity Status notification when reporting to the AF.

8. [Conditional-depending on the Event] The AMF detects the subscription change related event occurs, e.g., Subscription Correlation ID change due to AMF reallocation or addition of new Subscription Correlation ID due to a new group UE registered, the AMF sends the event report, e.g., by means of Namf_EventExposure_Notify message to the associated notification endpoint of the UDM.
a. If the user's notification event permission has been received from the UE during an earlier registration procedure, that will have been stored in the UDM. The UDM uses that UE requested permission setting to determine whether to authorize a notification event subscription received from a monitoring entity. The UDM may receive the request from the AF via the NEF.
b. If the monitoring request subscription is associated with regulatory reasons that override a subscriber's privacy, then the UDM ignores the user permissions for monitoring events and allows the monitoring to proceed irrespective of any user permission settings.
c. If no notification event permission has been received from the UE for the event type that is requested in the subscription, then the UDM uses a default notification event permission setting in the subscriber data to determine whether to authorize the notification event subscription or not.
d. The encoding of the UE user's request for privacy by denying or allowing the permission for the core network to generate monitoring events may be encoded in the registration request. The monitoring permissions may be added as an extension to an existing IE IEs (information element) or provided as part of an additional IE in the registration or similar request.

If a single allow/deny permission on all monitoring event types is supported, then a single bit may be used. The single bit may indicate with one state that monitoring is allowed and with the other state indicating that there is no monitoring permission. This may be provided in an indication provided by the UE to, for example, the AMF.

In another example, it is possible to encode the UE user's indication of monitoring permissions as a new IE in the registration request message. Examples of information elements (e.g., information) included in a registration message include information elements (e.g., information) shown in TS 24.501 in Table 8.2.6.1.1 and a new information element referred to as user permission for monitoring which an information element for monitoring permissions. In this example, the user permission for monitoring IE has a length of 5 octets but this is by way of example only. In other embodiments, the IE may be longer or shorter than 5 octets. All of the 5 octets may be used or only some of the 5 octets may be used.

| | Information | | Pre- | For- | |
|---|---|---|---|---|---|
| IEI | Element | Type/Reference | sence | mat | Length |
| | Extended protocol | Extended | M | V | 1 |
| | discriminator | Protocol | | | |
| | | discriminator 9.2 | | | |
| | Security header type | Security header | M | V | 1/2 |
| | | type 9.3 | | | |
| | Spare half octet | Spare half octet | M | V | 1/2 |
| | | 9.5 | | | |
| | Registration request | Message type | M | V | 1 |
| | message identity | 9.7 | | | |
| | 5GS registration type | 5GS registration | M | V | 1/2 |
| | | type 9.11.3.7 | | | |
| | ngKSI | NAS key set | M | V | 1/2 |
| | | identifier | | | |
| | | 9.11.3.32 | | | |
| | 5GS mobile | 5GS mobile | M | LV-E | 6-n |
| | identity | identity | | | |
| | | 9.11.3.4 | | | |
| C- | Non-current native | NAS key set | O | TV | 1 |
| | NAS key | identifier | | | |
| | set identifier | 9.11.3.32 | | | |
| 10 | 5GMM capability | 5GMM capability | O | TLV | 3-15 |
| | | 9.11.3.1 | | | |
| 2E | UE security | UE security | O | TLV | 4-10 |
| | capability | capability | | | |
| | | 9.11.3.54 | | | |
| 2F | Requested NSSAI | NSSAI | O | TLV | 4-74 |
| | | 9.11.3.37 | | | |
| 52 | Last visited | 5GS tracking | O | TV | 7 |
| | registered TAI | area identity | | | |
| | | 9.11.3.8 | | | |
| 17 | S1 UE network | S1 UE network | O | TLV | 4-15 |
| | capability | capability | | | |
| | | 9.11.3.48 | | | |
| 40 | Uplink data status | Uplink data status | O | TLV | 4-34 |
| | | 9.11.3.57 | | | |
| 50 | PDU session status | PDU session status | O | TLV | 4-34 |
| | | 9.11.3.44 | | | |
| B- | MICO indication | MICO indication | O | TV | 1 |
| | | 9.11.3.31 | | | |
| 2B | UE status | UE status | O | TLV | 3 |
| | | 9.11.3.56 | | | |
| 77 | Additional GUTI | 5GS mobile identity | O | TLV-E | 14 |
| | | 9.11.3.4 | | | |
| 25 | Allowed PDU | Allowed PDU | O | TLV | 4-34 |
| | session status | session status | | | |
| | | 9.11.3.13 | | | |
| 18 | UE's usage | UE's usage setting | O | TLV | 3 |
| | setting | 9.11.3.55 | | | |
| 51 | Requested DRX | 5GS DRX parameters | O | TLV | 3 |
| | parameters | 9.11.3.2A | | | |
| 70 | EPS NAS | EPS NAS | O | TLV-E | 4-n |
| | message | message container | | | |
| | container | 9.11.3.24 | | | |
| 74 | LADN | LADN indication | O | TLV-E | 3-811 |
| | indication | 9.11.3.29 | | | |
| 8- | Payload | Payload | O | TV | 1 |
| | container | container type | | | |
| | type | 9.11.3.40 | | | |
| 7B | Payload | Payload container | O | TLV-E | 14- |
| | container | 9.11.3.39 | | | 65538 |
| 9- | Network slicing | Network slicing | O | TV | 1 |
| | indication | indication | | | |
| | | 9.11.3.36 | | | |
| 53 | 5GS update type | 5GS update type | O | TLV | 3 |
| | | 9.11.3.9A | | | |
| 41 | Mobile station | Mobile station | O | TLV | 5 |
| | classmark 2 | classmark 2 | | | |
| | | 9.11.3.31C | | | |
| 42 | Supported codecs | Supported | O | TLV | 5-n |
| | | codec list | | | |
| | | 9.11.3.51A | | | |
| 71 | NAS message | NAS message | O | TLV-E | 4-n |
| | container | container | | | |
| | | 9.11.3.33 | | | |
| 60 | EPS bearer | EPS bearer | O | TLV | 4 |
| | context status | context status | | | |
| | | 9.11.3.23A | | | |
| 6E | Requested extended | Extended DRX | O | TLV | 3-4 |
| | DRX parameters | parameters | | | |
| | | 9.11.3.26A | | | |
| 6A | T3324 value | GPRS timer 3 | O | TLV | 3 |
| | | 9.11.2.5 | | | |
| 67 | UE radio | UE radio capability | O | TLV | 3-r |
| | capability ID | ID 9.11.3.68 | | | |
| 35 | Requested mapped | Mapped NSSAI | O | TLV | 3-42 |
| | NSSAI | 9.11.3.31B | | | |
| 48 | Additional | Additional | O | TLV | 3 |
| | information | information | | | |
| | requested | requested | | | |
| | | 9.11.3.12A | | | |
| 1A | Requested WUS | WUS assistance | O | TLV | 3-n |
| | assistance | information | | | |
| | information | 9.11.3.71 | | | |
| A- | N5GC indication | N5GC indication | O | TV | 1 |
| | | 9.11.3.72 | | | |
| 30 | Requested NB-N1 | NB-N1 mode DRX | O | TLV | 3 |
| | mode DRX | parameters | | | |
| | parameters | 9.11.3.73 | | | |
| 29 | UE request type | UE request type | O | TLV | 3 |
| | | 9.11.3.76 | | | |
| 28 | Paging restriction | Paging restriction | O | TLV | 3-35 |
| | | 9.11.3.77 | | | |
| 72 | Service-level- | Service-level-AA | O | TLV-E | 6-n |
| | AA container | container | | | |
| | | 9.11.2.10 | | | |
| 32 | NID | NID | O | TLV | 8 |
| | | 9.11.3.79 | | | |
| 16 | MS determined | PLMN identity | O | TLV | 5 |
| | PLMN with disaster | 9.11.3.85 | | | |
| | condition | | | | |
| 2A | Requested PEIPS | PEIPS assistance | O | TLV | 3-n |
| | assistance | information | | | |
| | information | 9.11.3.80 | | | |
| XX | User permission for | Monitoring | O | TLV | 5 |
| | monitoring | permissions | | | |

One illustrative example of a monitoring permission information element is given below.

| 8 | 7 | 6 | 5 | 4 | 3 | 2 | 1 | |
|---|---|---|---|---|---|---|---|---|
| Monitoring permissions IEI | | | | | | | | octet 1 |
| Length of Monitoring permissions | | | | | | | | octet 2 |
| P8 | P7 | P6 | P5 | P4 | P3 | P2 | P1 | octet 3 |
| P16 | P15 | P14 | P13 | P12 | P11 | P10 | P9 | octet 4* |
| spare | spare | spare | spare | spare | spare | spare | P17 | octet 5* |

In the following, examples of possible monitoring permissions assigned to different bits of the third, fourth and fifth octets of the IE are given. In this example, 7 bits of the last octet are unused or spare. It should be appreciated that this is by way of example only. There may be more than 7 spare bits or less than 7 spare bits or event no spare bits in other embodiments.

In the following 17 examples of monitoring permissions are given and are referenced P1 to P17 and are positioned as shown in the table above. It should be appreciated that in other embodiments, there may be more or less than 17 monitoring permissions. It should be appreciated that one or more different monitoring permissions may alternatively or additionally be provided. It should also appreciate that the particular monitoring permission assigned to a particular bit of a particular octet is by way of example only. In different embodiments, a given monitoring permission may be provided in a different octet and/or different bit in the octet.

In the following a given reporting permission for a UE which is allowed is associated with one value of the bit and the corresponding reporting permission for the UE which is not allowed is associated with the other value of the bit. In other embodiments, the opposite values may instead be used to denote if the particular reporting permission for a UE is allowed or not.

P1 Loss of connectivity monitoring permissions
0 Loss of connectivity monitoring not allowed
1 Loss of connectivity monitoring allowed.
P2 UE reachability monitoring permissions
0 UE reachability monitoring not allowed
1 UE reachability monitoring allowed
P3 Location reporting monitoring permissions
0 Location monitoring not allowed
1 Location monitoring allowed
P4 Change of SUPI-PEI association permissions
0 Change of SUPI-PEI association not allowed
1 Change of SUPI-PEI association allowed
P5 Roaming status monitoring permissions
0 Roaming status monitoring not allowed
1 Roaming status monitoring allowed
P6 Communication failure monitoring permissions
0 Communication failure monitoring not allowed
1 Communication failure monitoring allowed
P7 Availability after DL data notification failure monitoring permissions
0 Availability after DL data notification failure monitoring not allowed
1 Availability after DL data notification failure monitoring allowed
P8 PDU session status monitoring permissions
0 PDU session status monitoring not allowed
1 PDU session status monitoring allowed
P9 Number of UEs present in geographical area monitoring permissions
0 Number of UEs present in geographical area monitoring not allowed
1 Number of UEs present in geographical area monitoring allowed
   NOTE: This monitoring is related to all UEs that are present in an area, so it might not be appropriate in some embodiments to let any single UE to set the permissions for it. There may in some embodiments be no privacy issue, as this monitoring event returns just the UE count to the monitoring event subscriber
P10 CN type change monitoring permission
0 CN type change monitoring not allowed
1 CN type change monitoring allowed
P11 DL data delivery status monitoring permission
0 DL data delivery status monitoring not allowed
1 DL data delivery status monitoring allowed
P12 UE reachability for SMS delivery monitoring permissions
0 UE reachability for SMS delivery monitoring not allowed
1 UE reachability for SMS delivery monitoring allowed
P13 UE memory available for SMS monitoring permissions
0 UE memory available for SMS monitoring not allowed
1 UE memory available for SMS monitoring allowed
P14 Number of registered UEs or established PDU sessions monitoring permissions
0 Number of UEs or established PDU sessions monitoring not allowed
1 Number of UEs or established PDU sessions monitoring allowed
   NOTE: This monitoring is related to all UEs that are present in an area, so it might not be appropriate in some embodiments to let any single UE to set the permissions for it. There may in some embodiments be no privacy issue, as this monitoring event returns just the UE count to the monitoring event subscriber
P15 Area of Interest monitoring permissions
0 Area of interest monitoring not allowed
1 Area of interest monitoring allowed
P16 Group member list change monitoring permissions
0 Group member list change monitoring not allowed
1 Group member list change monitoring allowed
P17 Group-MBR monitoring permissions
0 Group-MBR monitoring not allowed
1 Group-MBR monitoring allowed
   The remaining code points may be encoded as “spare”.

In some embodiments, any of the IE examples discussed previously may be used in the message sent for the AMF to the UDM which indicates the monitoring permissions associated with a UE. The IE may be included in any suitable message from the AMF to the UDM. For example, the IE may be included in a registration message such as Nudm_UECM_Registration operation and/or an update message such as a Nudm_UECM_Update service operation.

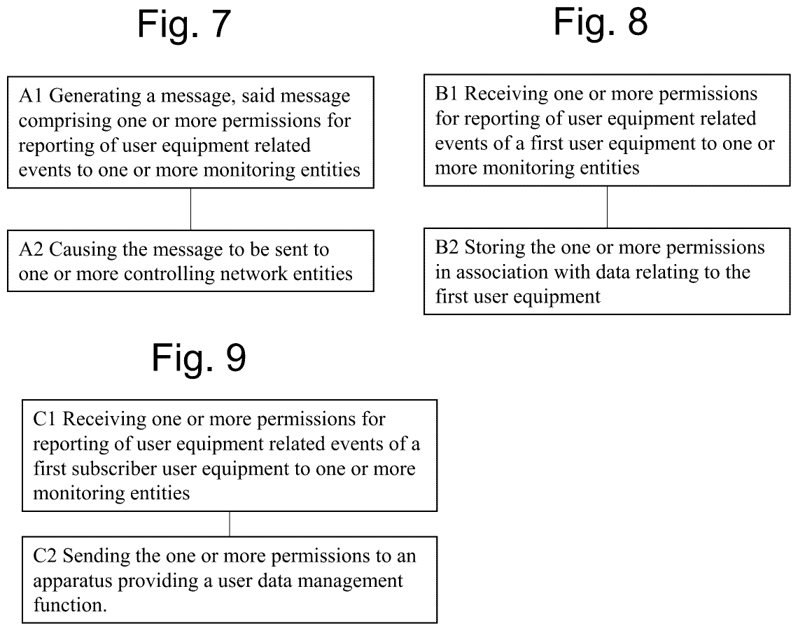

Reference is made to FIG. 7 which shows a method of some embodiments.

This method may be performed by an apparatus. The apparatus may a user equipment.

The apparatus may comprise suitable means, such as circuitry for providing the method.

Alternatively or additionally, the apparatus may comprise at least one processor and at least one memory storing instructions that, when executed by the at least one processor cause the apparatus at least to provide the method below.

Alternatively or additionally, the apparatus may be such as discussed in relation to FIG. 4.

The method may be provided by computer program code or computer executable instructions.

The method may comprise as referenced A1 generating a message, said message comprising one or more permissions for reporting of user equipment related events to one or more monitoring entities.

The method may comprise as referenced A2, causing the message to be sent to one or more controlling network entities.

It should be appreciated that the method outlined in FIG. 7 may be modified to include any of the previously described features.

Reference is made to FIG. 8 which shows a method of some embodiments.

This method may be performed by an apparatus. The apparatus may provide a user data management function.

The apparatus may comprise suitable means, such as circuitry for providing the method.

Alternatively or additionally, the apparatus may comprise at least one processor and at least one memory storing instructions that, when executed by the at least one processor cause the apparatus at least to provide the method below.

Alternatively or additionally, the apparatus may be such as discussed in relation to FIG. 3.

The method may be provided by computer program code or computer executable instructions.

The method may comprise as referenced B1, receiving one or more permissions for reporting of user equipment related events of a first user equipment to one or more monitoring entities.

The method may comprise as referenced B2, storing the one or more permissions in association with data relating to the first user equipment.

It should be appreciated that the method outlined in FIG. 8 may be modified to include any of the previously described features.

Reference is made to FIG. 9 which shows a method of some embodiments.

This method may be performed by an apparatus. The apparatus may provide an access and mobility function.

The apparatus may comprise suitable means, such as circuitry for providing the method.

Alternatively or additionally, the apparatus may comprise at least one processor and at least one memory storing instructions that, when executed by the at least one processor cause the apparatus at least to provide the method below.

Alternatively or additionally, the apparatus may be such as discussed in relation to FIG. 3.

The method may be provided by computer program code or computer executable instructions.

The method may comprise as referenced C1, receiving one or more permissions for reporting of user equipment related events of a first subscriber user equipment to one or more monitoring entities.

The method may comprise as referenced C2, sending the one or more permissions to an apparatus providing a user data management function.

It should be appreciated that the method outlined in FIG. 9 may be modified to include any of the previously described features.

Computer program code may be downloaded and stored in one or more memories of the relevant apparatus or device.

Therefore, although certain embodiments were described above by way of example with reference to certain example architectures for wireless networks, technologies and standards, embodiments may be applied to any other suitable forms of communication systems than those illustrated and described herein. In this example, some embodiments have been described in relation to a 5G network.

It is also noted herein that while the above describes example embodiments, there are several variations and modifications which may be made to the disclosed solution without departing from the scope of the present invention. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. In general, the various embodiments may be implemented in hardware or special purpose circuitry, software, logic, or any combination thereof. Some aspects of the disclosure may be implemented in hardware, while other aspects may be implemented in firmware or software which may be executed by a controller, microprocessor, or other computing device, although the disclosure is not limited thereto. While various aspects of the disclosure may be illustrated and described as block diagrams, flow charts, or using some other pictorial representation, it is well understood that these blocks, apparatus, systems, techniques, or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuits (such as only analog and/or digital circuits) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of the term “means” in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, an integrated circuit such as a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks, and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor-based memory devices, magnetic memory devices and systems, optical memory devices and systems, fixed memory, and removable memory. The data processors may be of any type suitable to the local technical environment, and may comprise one or more of general-purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiments of this disclosure. However, various modifications and adaptations may become apparent to those skilled in the relevant arts in view of the foregoing description, when read in conjunction with the accompanying drawings and the appended claims. Indeed, there are further embodiments comprising a combination of one or more embodiments with any of the other embodiments previously discussed. The scope of protection sought for some embodiments of the disclosure is set out by the claims. The embodiments and features, if any, described in this specification that do not fall under the scope of the claims are to be interpreted as examples useful for understanding various embodiments of the disclosure. It should be noted that different claims with differing claim scope may be pursued in related applications such as divisional or continuation applications.

1. A user equipment comprising:
at least one processor; and
at least one memory storing instructions that, when executed by the at least one processor, cause the user equipment at least to perform:
generating one or more permissions for reporting of user equipment related events to one or more monitoring entities; and
sending a message comprising the one or more permissions for reporting user equipment related events to one or more controlling network entities.

2. The user equipment as claimed in claim 1, wherein the one or more permissions included one shared permission for reporting two or more different types of user equipment related event.

3. The user equipment as claimed in claim 1, wherein said user equipment related events comprise two or more different types of user equipment related events which are associated with a respective permission.

4. The user equipment as claimed in claim 1, wherein the one or more permissions comprise at least two different permissions, and wherein sending comprises sending for the at least two permissions to different ones of the one or more monitoring entities.

5. The user equipment as claimed in claim 1, wherein the one or more permissions is used by one or more of the one or more controlling network entities to control whether to allow the one or more of the one or more controlling network entities to provide the user equipment related events to the one or more controlling network entities.

6. The user equipment as claimed in claim 1, wherein the message further comprises a time period associated with one or more of the one or more permissions that the one or more of the one or more permissions is valid.

7. The user equipment as claimed in claim 1, wherein the message comprises a registration request.

8. The user equipment as claimed in claim 1, wherein the instructions, when executed by the at least one processor, further cause the user equipment to perform:
determining that one or permissions for reporting of user equipment related events has changed; and
sending a further message to be generated with information about the one or more changed permissions for reporting of user equipment related events to the one or more controlling network entities.

9. The user equipment as claimed in claim 1, wherein the one or more user equipment related events comprise one or more of:
one or more loss of connectivity events;
one or more reachability of the user equipment events;
one or more location of the user equipment events;
one or more change of subscription permanent identifier-permanent equipment identifier association events;
one or more roaming status events;
one or more communication failure events;
one or more availability after downlink data notification failure events;
one or more protocol data unit session status monitoring permissions events;
one or more number of user equipment present in geographical area related;
one or more core network type change events;
one or more downlink data delivery status events;
one or more user equipment reachability for short message service delivery events;
one or more memory of the user equipment available for short message service events;
one or more number of registered user equipment events;
one or more established protocol data unit sessions events;
one or more area of interest events;
one or more group member list change events; or
one or more group-maximum bit rate events.

10. An apparatus comprising:
at least one processor; and
at least one memory storing instructions that, when executed by the at least one processor, cause the apparatus at least to perform:
receiving one or more permissions for reporting of user equipment related events of a first user equipment to one or more monitoring entities; and
storing the one or more permissions in association with data relating to the first user equipment.

11. The apparatus as claimed in claim 10, wherein the instructions, when executed by the at least one processor, further cause the apparatus to perform:
receiving a request, said request being a request sent by one of said one or more monitoring entities for notification of one or more user equipment related events of the first user equipment, and to determine based on the one or more permissions if the request for notification of one or more user equipment related events of the first user equipment is authorized.

12. The apparatus as claimed in claim 11, wherein the request is received from the one monitoring entity via an apparatus providing a network exposure function.

13. An apparatus comprising:
at least one processor; and
at least one memory storing instructions that, when executed by the at least one processor, cause the apparatus at least to perform:
receiving one or more permissions for reporting of user equipment related events of a first user equipment to one or more monitoring entities; and
sending the one or more permissions to an apparatus providing a user data management function of a communication network.

14. The apparatus as claimed in claim 13, wherein the one or more permissions for reporting of user equipment related events of the first user equipment are received from the first user equipment.
